(19) United States
(12) Patent Application Publication
(10) Pub. No.: US 2014/0074706 A1
(43) Pub. Date: Mar. 13, 2014

(54) FACILITATING TRANSACTION ABILITIES OF MULTIPLE FINANCIAL INSTITUTIONS

(71) Applicant: Loren Paulsen, Salem, OR (US)

(72) Inventor: Loren Paulsen, Salem, OR (US)

(73) Assignee: CU WIRELESS, Salem, OR (US)

(21) Appl. No.: 13/650,776

(22) Filed: Oct. 12, 2012

Related U.S. Application Data
(60) Provisional application No. 61/546,477, filed on Oct. 12, 2011.

(51) Int. Cl. G06Q 20/10

(52) U.S. Cl. CPC G06Q 20/108
USPC 705/42; 705/44

(57) ABSTRACT

Technologies and implementations for facilitating transaction capabilities of multiple financial institutions are generally disclosed.

### CROSS-REFERENCE TO RELATED APPLICATIONS

The present application claims priority to U.S. Provisional Patent Application No. 61/546,477, filed on Oct. 12, 2011, the entire contents of which are incorporated herein by reference.

### BACKGROUND

Unless otherwise indicated herein, the approaches described in this section are not prior art to the claims in this application and are not admitted to be prior art by inclusion in this section.

More and more people may be customers of more than one financial institution such as, but not limited to, a banking type institution. For example, a customer may have various accounts at multiple financial institutions, one account at one institution for savings, another account for mortgage, and yet another account for checking. Having accounts at different financial institutions can cause difficulties for the customer when attempting to conduct transactions between the accounts, and in particular, between various financial institutions.

### SUMMARY

Detailed herein are various illustrative methods for facilitating transaction capabilities between multiple financial institutions for a customer. Example methods may include at a financial institution management module, receiving a request to access two or more financial institutions from a device, responsive to the received request, requesting verification of account information from the device for the two or more financial institutions, determining if the requested verification of account information is received, and if it is determined that the requested verification of account information is received, providing access to the two or more financial institutions by the device. The provided access may include facilitating at least one of transaction capabilities between the device and the two or more financial institutions or transaction capabilities between the two or more financial institutions under direction and control of instructions from the device.

The present disclosure also describes various example machine readable non-transitory medium for facilitating transaction capabilities between multiple financial institutions for a customer. Example machine readable non-transitory medium having stored instructions that, when executed, operatively enable a financial institution management module to receive a request to access two or more financial institutions from a device, responsive to the received request, request verification of account information for the two or more financial institutions, determine if the requested verification of account information is received, and if it is determined that the requested verification of account information is received, provide access to the two or more financial institutions by the device. The provided access may include facilitating at least one of transaction capabilities between the device and the two or more financial institutions or transaction capabilities between the two or more financial institutions under direction and control of instructions from the device.

Additionally, the present disclosure describes example systems for facilitating transaction capabilities between multiple financial institutions for a customer. Example systems may include a financial institution management module and a machine readable having stored instructions that, when executed by one or more processors, may operatively enable the financial institution management module to receive a request to access two or more financial institutions from a device, responsive to the received request, request verification of account information for the two or more financial institutions, determine if the requested verification of account information is received, and if it is determined that the requested verification of account information is received, provide access to the two or more financial institutions by the device. The provided access may include facilitating at least one of transaction capabilities between the device and the two or more financial institutions or transaction capabilities between the two or more financial institutions under direction and control of instructions from the device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 illustrates a block diagram of an example system for facilitating transaction capabilities between multiple financial institutions for a customer;

FIG. 2 illustrates a block diagram of an example device having a user interface;

FIG. 3 illustrates a flow chart of an example method for facilitating transaction capabilities between multiple financial institutions for a customer;

FIG. 4 illustrates an example computer program product; and

FIG. 5 illustrates a block diagram of an example computing device, all arranged in accordance with at least some embodiments of the present disclosure.

### DETAILED DESCRIPTION

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

This disclosure is drawn, inter alia, to methods, apparatus, systems, and computer readable media related to facilitating transaction capabilities of multiple financial institutions.

As more users of financial institutions become electronically connected, a user may want to electronically make various financial transactions (e.g., transfer funds, make payments, make deposits, make withdrawals, etc.). Additionally, a user may have various accounts in more than one financial institution (e.g., a savings account at one financial institution, a checking account at another financial institution, a money market type account at yet another financial institution). The ability to manage the multiple accounts at more than one financial institution and conduct various financial transactions, including between financial institutions, may be difficult.

Various embodiments of the present disclosure may facilitate transaction capabilities between multiple financial institutions for a customer. The transaction capabilities may be in electronic form, and accordingly, the customer may utilize an electronic device of some kind. Additionally, the electronic device and the multiple financial institutions may be communicatively coupled via some form of network such as, but not limited to, the Internet. As a non-limiting example, a user may want to transfer funds from a savings account in one financial institution to a checking account in another financial institution using a mobile device (e.g., a mobile phone) via the Internet. As another alternate example, using a mobile device such as smart phone, a user may want to deposit a paper check into a checking account in one financial institution, while also electronically paying a bill from another financial institution. In yet another non-limiting example, a user may want to add funds to their mobile device from a checking account in one financial institution and another checking account in another financial institution, and thereby, facilitate some form of mobile payment. In order to help facilitate these transaction capabilities, a financial institution management module may be involved, where the financial institution management module may be communicatively coupled to one or more financial institutions and a device.

As indicated, the above examples may be provided for illustrative purposes only and is not intended to be limiting. It should be appreciated that multiple financial institutions, multiple devices (i.e., users/customers), and multiple financial institution management modules are at least contemplated, including ubiquitous computing via a wide variety of networks.

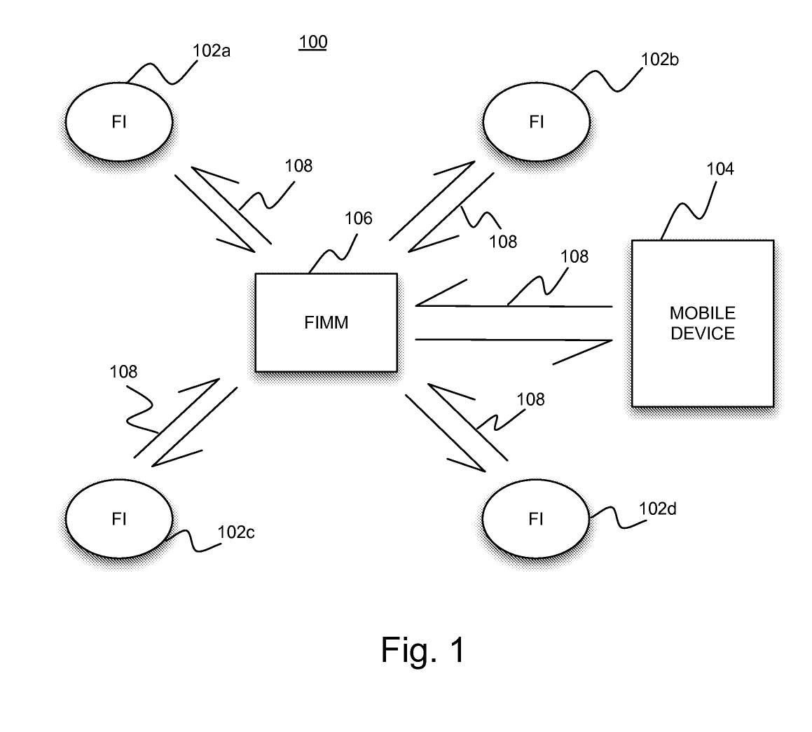

Turning now to the Figures, FIG. 1 illustrates a block diagram of an example system 100 for facilitating transaction capabilities between multiple financial institutions for a customer, arranged in accordance with at least some embodiments of the present disclosure. The system 100 may include financial institutions 102a-102d, a mobile device 104, and a financial institution management module 106. The financial institutions 102a-102d, the mobile device 104, and the financial institution management module 106 may be communicatively coupled to each other via the Internet 108 (e.g., via a cellular data connection, via a Wi-Fi connection, via a wired LAN connection, or the like).

In general, the financial institution management module 106 may be configured to centrally (i.e., hub and spoke type arrangement) help facilitate transaction capabilities between the financial institutions 102a-102d and the mobile device 104. For example, the financial institution management module 106 may receive a request to access two or more of the financial institutions 102a-102d from the mobile device 104 via the Internet 108. In one example, the request may be to transfer funds between the two or more financial institutions (e.g., transfer funds from financial institution 102a to financial institution 102b). For ease of description, financial institution 102a will be referred to “Bank A” and financial institution 102b will be referred to as “Bank B”. Additionally, going forward the financial institution management module 106 will be referred to as “FIMM”.

In FIG. 1, responsive to the received request, the FIMM 106 may request verification of account information for Bank A 102a and Bank B 102b. In one example, the FIMM 106 may request a single verification information associated with Bank A 102a and Bank B 102b. The single verification may be at least in the form of a login (e.g., user name and password) or at least in the form of a verification transaction (e.g., FIMM 106 may make a minimal deposit and/or withdrawal from each of the accounts in Bank A 102a and Bank B 102b and ask for verification of the amount transacted). The FIMM 106 may determine if the requested verification of account information is received, and if it is determined that the requested verification of account information is received, the FIMM 106 may provide access to Bank A 102a and Bank B 102b. However, if it is determined that verification of account information is not received or received correctly (i.e., invalid login and/or non-matching verification transaction), the FIMM 106 may transmit an error message to the mobile device 104 as one example. As another example, if it is determined that verification of account information is not received or received correctly, the FIMM 106 may terminate communications with the mobile device 104.

Once the FIMM 106 provides access to Bank A 102a and to Bank B 102b by the mobile device 104, the FIMM 106 may be capable of receiving instructions from the mobile device 104 to transfer deposit checks into Bank A 102a for example or to withdrawal funds from Bank B 102b for example (i.e., between Bank A 102a and/or Bank B 102b and the mobile device 104). Additionally, FIMM 106 may be capable of receiving instructions from the mobile device 104 to transfer funds from Bank A 102a to Bank B 102b (i.e., between Bank A 102a and Bank B 102b under the direction and control of a user/customer using the mobile device 104). Accordingly, the FIMM 106 may help facilitate transaction capabilities between Bank A 102a, Bank B 102b, and the mobile device 104.

Shown in FIG. 1 are Bank A 102a, Bank B 102b, financial institutions 102c-102d, and FIMM 106 may all be communicatively coupled via the Internet 108 for one example. In another example, Bank A 102a, Bank B 102b, financial institutions 102c-102d, and FIMM 106 may all be communicatively coupled via a network utilizing an interbank network such as, but not limited to, a Shared Branching type network (e.g., an extension of an ATM type network). In yet another example, Bank A 102a, Bank B 102b, financial institutions 102c-102d, and FIMM 106 may all be communicatively coupled via ubiquitous computing network such as, but not limited to, a cloud network. It should also be appreciated that at least these example networks may also be applicable to the manner in which the mobile device 104 may be communicatively coupled to the FIMM 106 via the network 108 including but not limited to a wireless connection (e.g., cellular data connection, Wi-Fi hotspot, Bluetooth, tethering, near field communication, infrared, and/or the like). Further, even though the disclosed subject matter may have been discuss using a mobile device, it should be appreciated that it is contemplated that mobile device 104 may also be a desktop type device, server type device, a mobile phone, smart phone, tablet PC, or any other device that may be capable of communicatively coupling with a network and/or another device. The mobile device 104 may also be capable of utilizing text based and/or SMS based financial transactions, mobile payments, near field communication, direct mobile billing, and/or any combination thereof, and accordingly, the claimed subject matter is not limited in these respects.

Financial transactions may include a wide variety of transactions such as, but not limited to, electronic funds transfers, electronic deposits (e.g., physical paper type utilizing image processing technology), payments to vendors including providing a solution for vendors to be incorporated into transactions, and so forth, and accordingly, the claimed subject matter is not limited in these respects. Further, it is contemplated within the scope of the claimed subject matter that financial institution may include a wide variety to institutions such as but not limited to, banks, credit unions, exchanges, government institutions (e.g., national treasury), and so forth, and accordingly, the claimed subject matter is not limited in these respects.

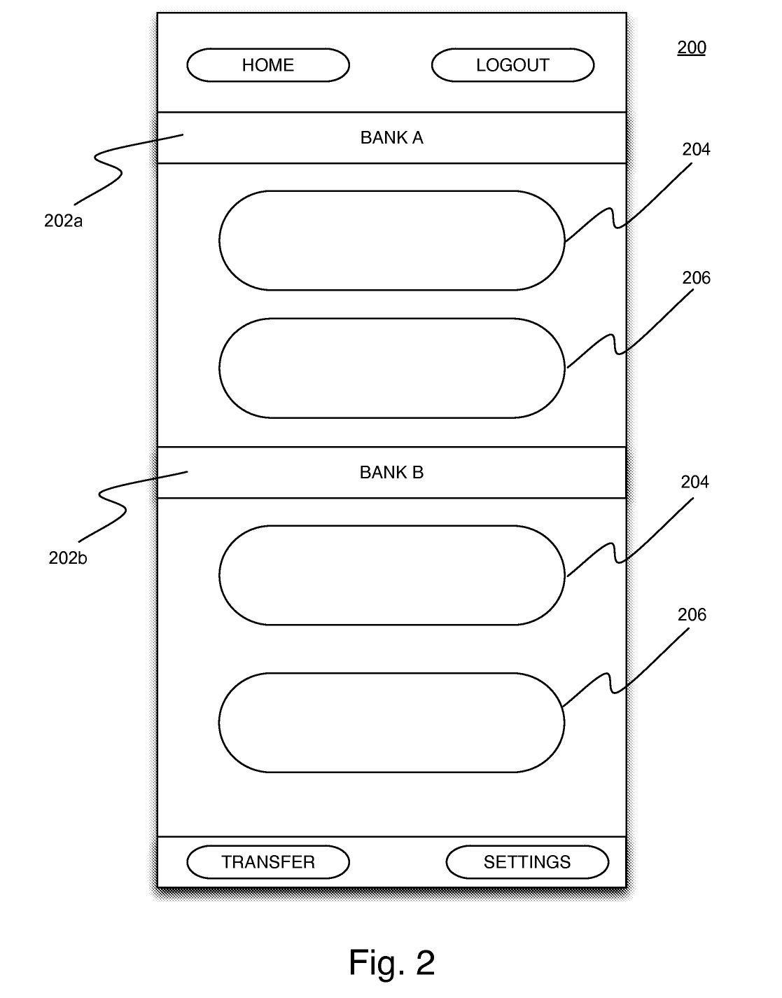

FIG. 2 illustrates a block diagram of a user interface 200 for facilitating transaction capabilities between multiple financial institutions for a customer, arranged in accordance with at least some embodiments of the present disclosure. In FIG. 2, the user interface 200 may include various information regarding two or more financial institutions such as those previously described with respect to FIG. 1. For example, the user interface 200 may include information regarding Bank A 202a and Bank B 202b. Information such as, but not limited to, a type of account 204 (e.g., savings, checking, line of credit, credit card, line of equity, money market, mortgage, etc.) and/or a type of transaction 206 (e.g., deposit, withdrawal, transfer, payment, etc.) for one or more of the financial institutions. Accordingly, the user interface 200 may help facilitate management of the transaction capabilities between Bank A 202a, Bank B 202b by the user/customer (not shown). The user/customer may use the user interface 200 to direct and control the various transaction capabilities between a device and two or more financial institutions.

Shown in FIG. 2, the user interface 200 may be considered to be more optimized for a handheld type device having relatively small screens such as, but not limited to mobile phones, smart phones, “phablet” type phones (larger than a typical handheld smart phone), and so forth. However, it should be appreciated that it is contemplated within the scope of the claimed subject matter that the user interface 200 may be optimized for larger screens such as, but not limited to, full size monitors, tablets type devices, etc. Additionally, for ease of understanding, the user interface is shown as a graphical user type interface (GUI). However, it should be appreciated that it is contemplated within the scope of the claimed subject matter that the user interface may be of any type such as, but no limited to, text based type user interface. Accordingly, the claimed subject matter is not limited in these respects.

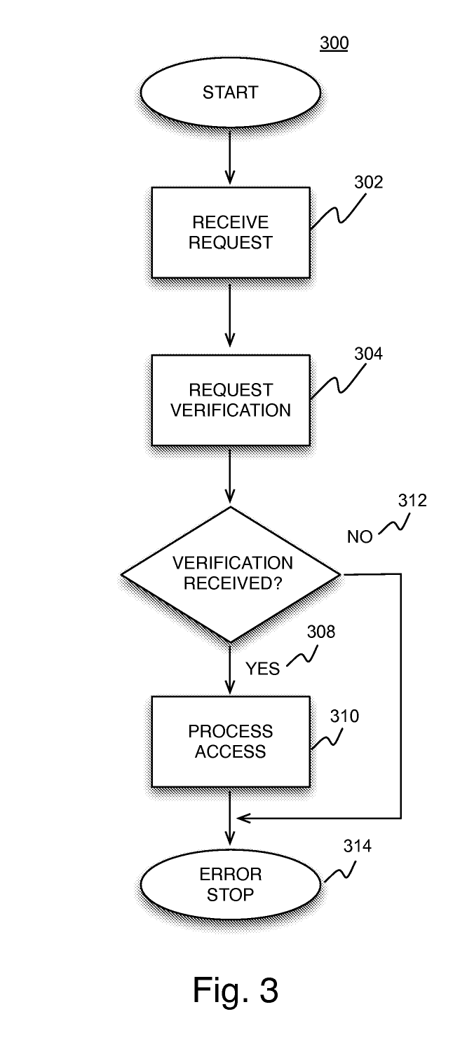

FIG. 3 illustrates a flow chart of example method 300 for facilitating transaction capabilities of multiple financial institutions, in accordance with at least some embodiments of the present disclosure. In some portions of the description, illustrative implementation of method 300 may be described with reference to components of the system 100 and the user interface 200 depicted in FIGS. 1 and 2. However, the described embodiments are not limited to this depiction. More specifically, some components depicted in FIGS. 1 and 2 may be omitted from example implementations of the method detailed herein. Furthermore, other components not depicted in FIGS. 1 and 2 may be used to implement example method.

Additionally, FIG. 3 may employ block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and others not described, rearrangements, substitutions, changes, modifications, etc., may be made without departing from the scope of claimed subject matter.

Turning now to the method 300 and FIG. 3, beginning at block 302, “Receive Request to Access”, the FIMM 106 may include logic and/or features configured to receive a request to access two or more financial institutions (e.g., Bank A 102a, Bank B 102b, and 102c-102d) from a device (e.g., mobile device 104). The request may be to perform a financial transaction of some kind as previously described. In some embodiments, the request may be received via the Internet. In some other embodiments, the request may be received via a shared branching network. In some other embodiments, the request may be received via a ubiquitous computing environment (e.g., a cloud computing environment).

Continuing from block 302 to block 304, “Request Verification”, the FIMM 106 may include logic and/or features configured to, responsive to the received request, request verification of account information for the two or more financial institutions (e.g., Bank A 102a, Bank B 102b, and 102c-102d). In some embodiments, the request for the verification of account information may be a single verification request associated with the two or more financial institutions (e.g., Bank A 102a, Bank B 102b, and 102c-102d) such as, but not limited to login information and/or a verification transaction.

Continuing from block 304 to determination block 306, “Verification Received?”, the FIMM 106 may include logic and/or features configured to determine if the requested verification of account information is received. The FIMM 106 may make the determination based on a variety of manners such as, but not limited to, a look up table stored in some memory, contacting the two or more financial institutions, and so forth, and accordingly, the claimed subject matter in not limited in these respects.

At determination block 306, if it is determined that the requested verification of account information is received (YES 308), the method 300 may continue from block 306 to block 310, “Provide Access”, the FIMM 106 may include logic and/or features configured to provide access to the two or more financial institutions (e.g., Bank A 102a, Bank B 102b, and 102c-102d). As previously described, the provided access may include facilitating at least one of transaction capabilities between the device (mobile device 104) and the two or more financial institutions (e.g., Bank A 102a, Bank B 102b, and 102c-102d) or transaction capabilities between the two or more financial institutions (e.g., Bank A 102a, Bank B 102b, and 102c-102d) under the direction and control of instructions from the device (mobile device 104). If however, it is determined that verification of account information is not received (NO 312), the FIMM 106 may include logic and/or features configured to transmit an error message to the device in one example. Alternatively, it is determined that verification of account information is not received (NO 312), the FIMM 106 may include logic and/or features configured to terminate communications with the device in another example. As a result, transaction capabilities of multiple financial institutions may be facilitated.

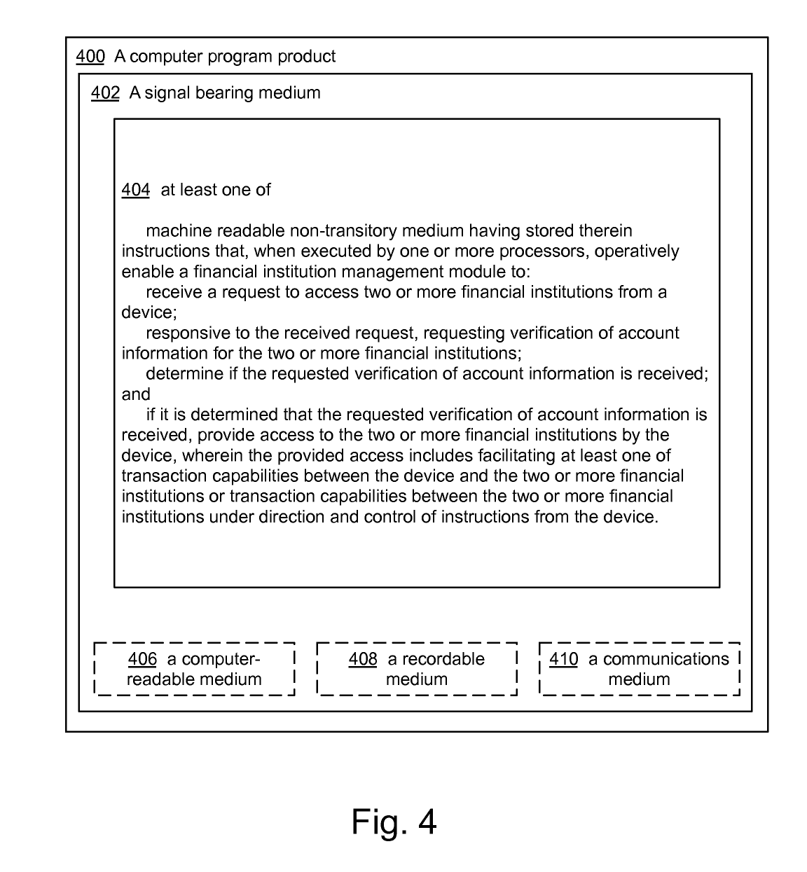

FIG. 4 illustrates an example computer program product 400 that is arranged in accordance with at least some examples of the present disclosure. Program product 400 may include a signal bearing medium 402. Signal bearing medium 402 may include one or more machine-readable instructions 404, which, if executed by one or more processors, may operatively enable a computing device to provide a functionality such as, but not limited to, receive a request to access two or more financial institutions from a device, and responsive to the received request, request verification of account information for the two or more financial institutions. Additionally, the instructions may determine if the requested verification of account information is received. If it is determined that the requested verification of account information is received, the instructions may provide access to the two or more financial institutions by the device, where the access may include facilitating at least one of transaction capabilities between the device and the two or more financial institutions or transaction capabilities between the two or more financial institutions under direction and control of instructions received from the device, in accordance with various embodiments of the disclosure.

In some implementations, signal bearing medium 402 may encompass a non-transitory computer-readable medium 406, such as, but not limited to, a hard disk drive, a Compact Disc (CD), a Digital Versatile Disk (DVD), a digital tape, memory, etc. In some implementations, signal bearing medium 702 may encompass a recordable medium 408, such as, but not limited to, memory, read/write (R/W) CDs, R/W DVDs, etc. In some implementations, signal bearing medium 402 may encompass communications medium 410, such as, but not limited to, a digital and/or an analog communication medium (e.g., a fiber optic cable, a waveguide, a wired communications link, a wireless communication link, etc.).

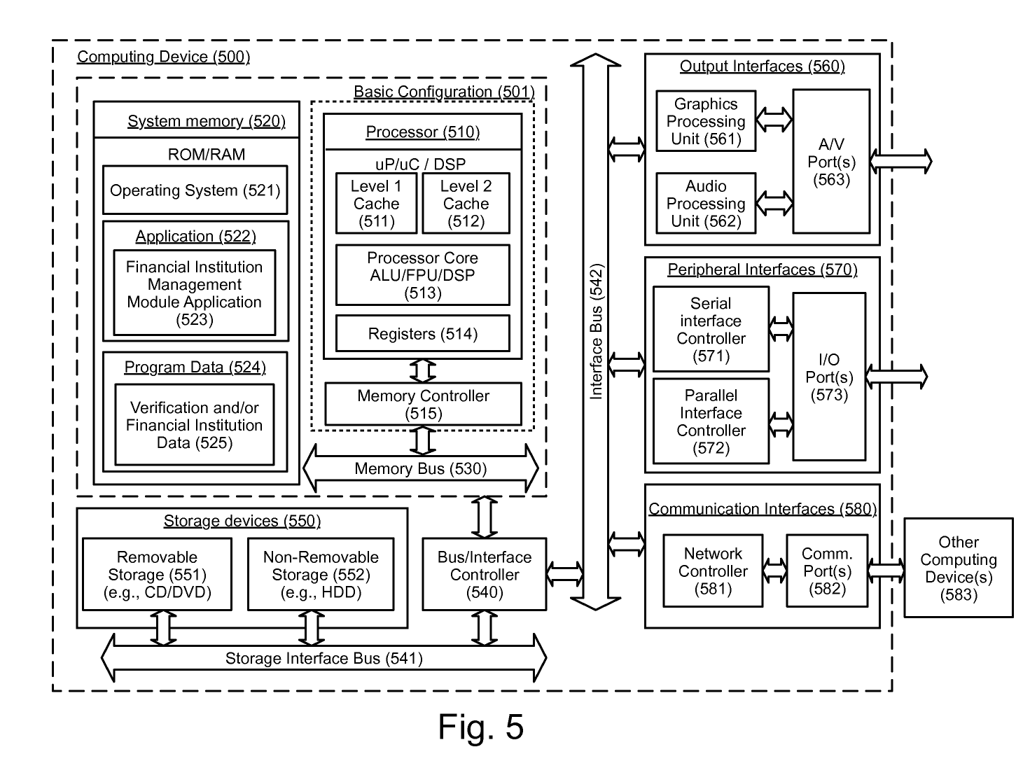

FIG. 5 is a block diagram illustrating an example computing device 500 arranged in accordance with at least some embodiments of the present disclosure. In various examples, the computing device 500 may be configured to facilitate transaction capabilities of multiple financial institutions as discussed herein. In one example of a basic configuration 501, computing device 500 may include one or more processors 510 and system memory 520. A memory bus 530 may be used for communicating between the processor 510 and the system memory 520.

Depending on the desired configuration, the one or more processors 510 may be of any type including but not limited to a microprocessor (μP), a microcontroller (μC), a digital signal processor (DSP), or any combination thereof. The one or more processors 510 may include one or more levels of caching, such as a level one cache 511 and a level two cache 512, a processor core 513, and registers 514. The processor core 513 can include an arithmetic logic unit (ALU), a floating point unit (FPU), a digital signal processing core (DSP Core), or any combination thereof. A memory controller 515 can also be used with the one or more processors 510, or in some implementations the memory controller 515 can be an internal part of the processor 510.

Depending on the desired configuration, the system memory 520 may be of any type including but not limited to volatile memory (such as RAM), non-volatile memory (such as ROM, flash memory, etc.) or any combination thereof. The system memory 520 may include an operating system 521, one or more applications 522, and program data 524. The one or more applications 522 may include a financial institution management module application 523 that can be arranged to perform the functions, actions, and/or operations as described herein including the functional blocks, actions, and/or operations described herein. The program data 524 may include verification of account information and/or financial institution data 525 for use with the financial institution management module application 523. In some example embodiments, the one or more applications 522 may be arranged to operate with the program data 524 on the operating system 521. This described basic configuration 501 is illustrated in FIG. 5 by those components within dashed line.

The computing device 500 may have additional features or functionality, and additional interfaces to facilitate communications between the basic configuration 501 and any required devices and interfaces. For example, a bus/interface controller 540 may be used to facilitate communications between the basic configuration 501 and one or more data storage devices 550 via a storage interface bus 541. The one or more data storage devices 550 may be removable storage devices 551, non-removable storage devices 552, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 520, the removable storage 551 and the non-removable storage 552 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 542 for facilitating communication from various interface devices (e.g., output interfaces, peripheral interfaces, and communication interfaces) to the basic configuration 501 via the bus/interface controller 540. Example output interfaces 560 may include a graphics processing unit 561 and an audio processing unit 562, which may be configured to communicate to various external devices such as a display or speakers via one or more NV ports 563. Example peripheral interfaces 570 may include a serial interface controller 571 or a parallel interface controller 572, which may be configured to communicate with external devices such as input devices (e.g., keyboard, mouse, pen, voice input device, touch input device, etc.) or other peripheral devices (e.g., printer, scanner, etc.) via one or more I/O ports 573. An example communication interface 580 includes a network controller 751, which may be arranged to facilitate communications with one or more other computing devices 583 over a network communication via one or more communication ports 582. A communication connection is one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 500 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. The computing device 500 may also be implemented as a personal computer including both laptop computer and non-laptop computer configurations. In addition, the computing device 500 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for facilitating transactions by a financial institution management module, the method comprising:
receiving a request to access two or more financial institutions from a device;
responsive to the received request, requesting verification of account information for the two or more financial institutions;
determining if the requested verification of account information is received; and
if it is determined that the requested verification of account information is received, providing access to the two or more financial institutions by the device, wherein the provided access includes facilitating at least one of transaction capabilities between the device and the two or more financial institutions or transaction capabilities between the two or more financial institutions under direction and control of instructions received from the device.

2. The method of claim 1, wherein receiving the request comprises receiving a request from a mobile device.

3. The method of claim 1, wherein requesting verification of account information comprises requesting a single verification associated with the two or more financial institutions.

4. The method of claim 3, wherein requesting the single verification comprises requesting login information.

5. The method of claim 3, wherein requesting the single verification comprises a requesting a verification transaction at the two or more financial institutions.

6. The method of claim 1, further comprising:
if it determined that the requested verification of account information is not received, transmitting an error message to the device.

7. The method of claim 1, further comprising:
if it determined that the requested verification of account information is not received, terminating communications with the device.

8. The method of claim 1, wherein receiving the request comprises receiving the request via the Internet.

9. The method of claim 1, wherein receiving the request comprises receiving the request via a shared branching network.

10. The method of claim 1, wherein receiving the request comprises receiving the request via a cloud computing environment.

11. A machine readable non-transitory medium having stored therein instructions that, when executed by one or more processors, operatively enable a financial institution management module to:
receive a request to access two or more financial institutions from a device;
responsive to the received request, request verification of account information for the two or more financial institutions;
determine if the requested verification of account information is received; and
if it is determined that the requested verification of account information is received, provide access to the two or more financial institutions by the device, wherein the provided access includes facilitating at least one of transaction capabilities between the device and the two or more financial institutions or transaction capabilities between the two or more financial institutions under direction and control of instructions from the device.

12. The machine readable non-transitory medium of claim 11, wherein the stored instructions that, when executed by one or more processors, further operatively enable the financial institution management module to receive a request from a mobile device.

13. The machine readable non-transitory medium of claim 11, wherein the stored instructions that, when executed by one or more processors, further operatively enable the financial institution management module to request a single verification associated with the two or more financial institutions.

14. The machine readable non-transitory medium of claim 13, wherein the stored instructions that, when executed by one or more processors, further operatively enable the financial institution management module to request login information.

15. The machine readable non-transitory medium of claim 13, wherein the stored instructions that, when executed by one or more processors, further operatively enable the financial institution management module to request a verification transaction at the two or more financial institutions.

16. The machine readable non-transitory medium of claim 11, wherein the stored instructions that, when executed by one or more processors, further operatively enable the financial institution management module to transmit an error message to the device if it is determined that the requested verification of account information is not received.

17. The machine readable non-transitory medium of claim 11, wherein the stored instructions that, when executed by one or more processors, further operatively enable the financial institution management module to terminate communications with the device if it is determined that the requested verification of account information is not received.

18. The machine readable non-transitory medium of claim 11, wherein the stored instructions that, when executed by one or more processors, further operatively enable the financial institution management module to receive the request via the Internet.

19. The machine readable non-transitory medium of claim 11, wherein the stored instructions that, when executed by one or more processors, further operatively enable the financial institution management module to receive the request via a shared branching network.

20. The machine readable non-transitory medium of claim 11, wherein the stored instructions that, when executed by one or more processors, further operatively enable the financial institution management module to receive the request via a cloud computing environment.

21. A system comprising:
a financial institution management module; and
a machine readable medium having stored therein instructions that, when executed by one or more processors, cause the financial institution management module to:
receive a request to access two or more financial institutions from a device;
responsive to the received request, request verification of account information for the two or more financial institutions;
determine if the requested verification of account information is received; and
if it is determined that the requested verification of account information is received, provide access to the two or more financial institutions by the device, wherein the provided access includes facilitating at least one of transaction capabilities between the device and the two or more financial institutions or transaction capabilities between the two or more financial institutions under direction and control of instructions from the device.

22. The system of claim 21, wherein the stored instructions that, when executed by one or more processors, further operatively enable the financial institution management module to receive a request from a mobile device.

23. The system of claim 21, wherein the stored instructions that, when executed by one or more processors, further operatively enable the financial institution management module to request a single verification associated with the two or more financial institutions.

24. The system of claim 23, wherein the stored instructions that, when executed by one or more processors, further operatively enable the financial institution management module to request login information.

25. The system of claim 23, wherein the stored instructions that, when executed by one or more processors, further operatively enable the financial institution management module to request a verification transaction at the two or more financial institutions.

26. The system of claim 21, wherein the stored instructions that, when executed by one or more processors, further operatively enable the financial institution management module to transmit an error message to the device if it is determined that the requested verification of account information is not received.

27. The system of claim 21, wherein the stored instructions that, when executed by one or more processors, further operatively enable the financial institution management module to terminate communications with the device if it is determined that the requested verification of account information is not received.

28. The system of claim 21, wherein the stored instructions that, when executed by one or more processors, further operatively enable the financial institution management module to receive the request via the Internet.

29. The system of claim 21, wherein the stored instructions that, when executed by one or more processors, further operatively enable the financial institution management module to receive the request via a shared branching network.

30. The system of claim 21, wherein the stored instructions that, when executed by one or more processors, further operatively enable the financial institution management module to receive the request via a cloud computing environment.
